(19) United States
(12) Patent Application Publication
(10) Pub. No.: US 2008/0154697 A1
(43) Pub. Date: Jun. 26, 2008

(54) Like-Minded People Proximity Detection and Interest Matching System

(75) Inventors: Shai Guday, Redmond, WA (US); Eric Horvitz, Kirkland, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/615,687

(22) Filed: Dec. 22, 2006

(51) Int. Cl. G06F 17/30

(52) U.S. Cl. 705/10

(57) ABSTRACT

Technologies for allowing people or other entities to detect others with common interests, particularly when proximate to one another. A user can configure a mobile device with information about his interests, such as things they wish to buy or sell, the kinds of people they would like to meet, or any other interests. Such a mobile device may federate with other similarly-enabled devices such that interest information is exchanged and interest matches are sought. Such exchanges and/or matching may be limited by physical or geographic proximity, such as when two people are physically close to one another. Upon discovery of a match, the user is typically notified of the match and the user's contact information may be forwarded to the other matching user's device.

### BACKGROUND

Throughout history people have been interested in meeting other people with similar interests to their own. Such interests may include buy-sell interests, common hobbies, a desire to meet another person with certain characteristics, or any other common interests. For example, a person may be interested in acquiring a certain breed of dog and be in search of such a breeder. Or a person may desire to meet other Yankee fans while in a bar. Discovering other like-minded people historically demands a significant amount of communication and time and like-minded people often go undiscovered even though they may be near by.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present examples provide technologies for allowing people or other entities to detect others with common interests, particularly when proximate to one another. A user can configure a mobile device with information about his interests, such as things they wish to buy or sell, the kinds of people they would like to meet, or any other interests. Such a mobile device may federate with other similarly-enabled devices such that interest information is exchanged and interest matches are sought. Such exchanges and/or matching may be limited by physical or geographic proximity, such as when two people are physically close to one another. Upon discovery of a match, the user is typically notified of the match and the user's contact information may be forwarded to the other matching user's device.

Many of the attendant features will be more readily appreciated as the same become better understood by reference to the following detailed description considered in connection with the accompanying drawings.

### DESCRIPTION OF THE DRAWINGS

The present description will be better understood from the following detailed description considered in connection with the accompanying drawings, wherein:

FIG. 1 is a block diagram showing example mobile devices coupled together via a network and to a like-minded people (“LMP”) server and database or LMP data store.

FIG. 2 is a block diagram showing example mobile devices coupled together via an ad-hoc network.

FIG. 3 is a block diagram showing an example of like-minded people (“LMP”) data.

FIG. 4 is a block diagram showing an example like-minded people (“LMP”) device or system.

FIG. 5 is a block diagram showing an example process for detecting common interests among persons represented by devices in a federation of devices.

FIG. 6 is a block diagram showing an example computing environment 600 in which the technologies described above may be implemented.

Like reference numerals are used to designate like parts in the accompanying drawings.

### DETAILED DESCRIPTION

The detailed description provided below in connection with the accompanying drawings is intended as a description of the present examples and is not intended to represent the only forms in which the present examples may be constructed or utilized. The description sets forth at least some of the functions of the examples and/or the sequence of steps for constructing and operating examples. However, the same or equivalent functions and sequences may be accomplished by different examples.

Although the present examples are described and illustrated herein as being implemented in a computing and networking environment, the environment described is provided as an example and not a limitation. As those skilled in the art will appreciate, the present examples are suitable for application in a variety of different types of computing and communications environments.

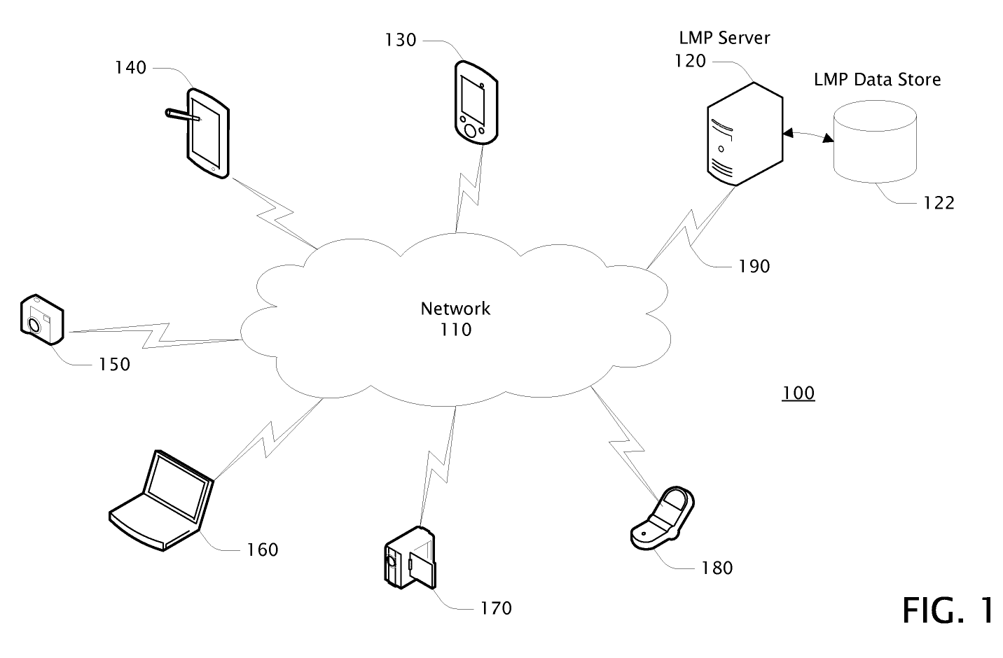

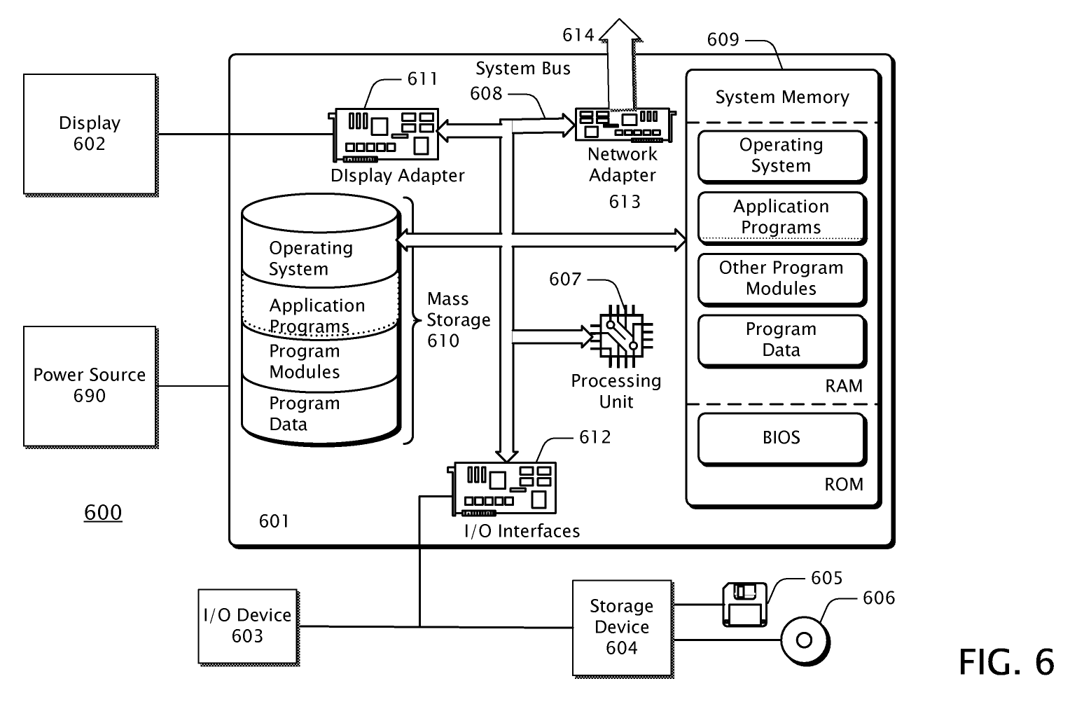

FIG. 1 is a block diagram showing example mobile devices coupled together via a network 110 and to a like-minded people (“LMP”) server 120 and database or LMP data store 122. Example devices may include personal data assistant (“PDA”) 130, tablet personal computer (“PC”) 140, digital camera 150, laptop PC 160, digital video recorder (“DVR”) 170, and cell phone 180. Such devices may be operable to at least determine their physical location. Some such devices may include an example computing environment such as that described in connection with FIG. 6. Many other types of devices may also be coupled with the forgoing devices via network 110 or other means. Such devices may include mobile devices or other devices such as desktop PCs, servers, systems, or any other type of mobile or non-mobile device that may contribute to and/or benefit from LMP proximity and interest matching, Further examples of such devices include vehicles or any other device, system, construct, composition, or the like operable to at least recognize and/or support LMP information.

Devices may be coupled to network 110 via any operable link, such as example link 190. Such links may include a network interface card (“NIC”), a serial or parallel port, a data bus, an analog interface, or the like, may be wired or wireless, may make use of infrared (“IR”), acoustics, optics, radios frequency (“RF”), or the like. Network 110 may be an ad-hoc network with mobile devices coupling transiently. Server devices, such as server 120, and other non- or less-mobile devices, may be coupled to network 110 more persistently than mobile devices. In one example, network 110 may be a wireless fidelity (“Wi-Fi”) network at a municipal facility, coffee shop, city library, courtroom, or airport lounge, or may be deployed across a neighborhood, city, county or other area. Mobile and other devices may typically link to such a Wi-Fi network via wireless adapters or any other suitable means. Such devices may also be operable to link to other types of networks. In another example, cell phones may link to a cellular network via appropriate RF adapters and protocols or other suitable means. Such cell phones may also be operable to link to other types of networks, such as Wi-Fi networks or the like. Network coupled devices may form and/or join federations of devices.

LMP server 120 may send and receive virtual graffiti information to other devices coupled to network 110, may process such virtual graffiti information, and may send such information to other devices coupled to network 110. LMP data store 122 may be utilized by LMP server 120 to store LMP data or the like including such received from various devices coupled to network 110 or otherwise coupled. In one example, LMP server 120 and database 122 may be an LMP appliance—a special-purpose device or system or the like primarily intended to provide LMP server and/or database functionality. Such an LMP appliance may be coupled to network 110 via any operable link, such as example link 190. Alternatively, a LMP appliance may provide a subset of LMP server and/or database functionality and/or may not be coupled to a network. Such an appliance may simply emit LMP information via RF means or acoustic means or the like.

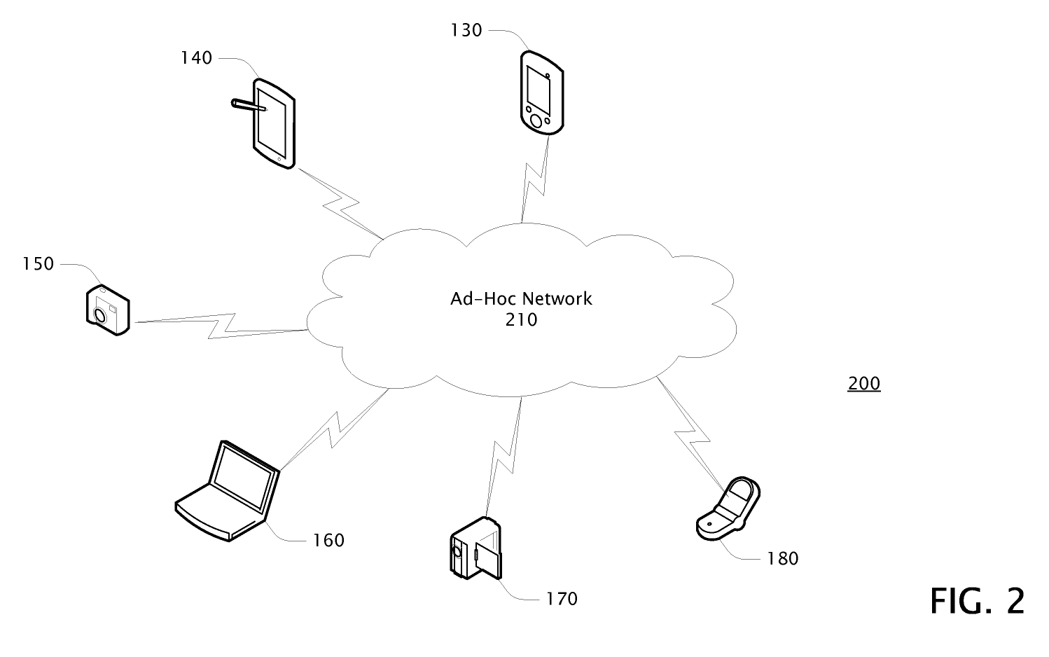

FIG. 2 is a block diagram showing example mobile devices coupled together via an ad-hoc network 210. Such an ad-hoc network may not include any persistent devices such as LMP servers or related data stores. Ad-hoc networks for LMP purposes may be formed as various mobile or other devices dynamically form and join such networks. For example, an ad-hoc network may be formed comprising devices of people on a particular bus or in a particular office, building, or area. In another example, such an ad-hoc network may be formed comprising devices carried by members of a particular family and perhaps their friends, by members of a club, group, association, or the like, by employees of a company, or by anyone interested in discovering like-minded people without any other restriction, etc. Example devices shown in FIG. 2 include those described in connection with FIG. 1. Such an ad-hoc network may make use of the Internet, a corporate network, or any other type of network or combination of networks or the like, and devices coupled to such an ad-hoc network be separated by vast physical distances. Ad-hoc network coupled devices may form and/or join federations of devices.

The term “federation of devices” is generally intended to mean a grouping, collection, partnership, association, coalition, or the like of devices such that the devices may collaborate, interact, communicate, or the like via some means and for some purpose. In particular, a federation of such devices may interact for virtual graffiti purposes. A “federated device” is generally a device that is part of a federation of devices. Such as device may federate with other devices briefly or for a longer period of time. A federation of devices may be established via some formal means or via some ad-hoc means. The devices of such a federation of devices may collaborate, interact, communicate, or the like via a means such as a network, ad-hoc network, virtual network, RF transmissions, acoustics, IR, any other suitable means, or any combination of the foregoing. An ad-hoc federation generally means a transient federation or a federation in which one or more of the federated devices tends to join and/or leave in a transient manner, typically without a long-term relationship to the ad-hoc federation.

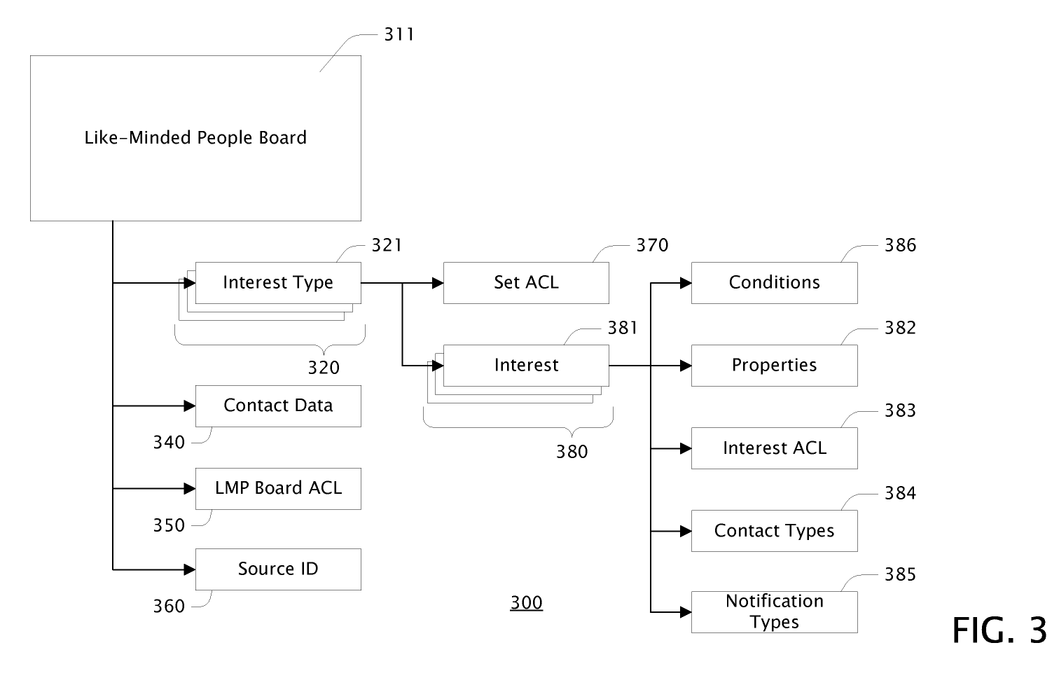

FIG. 3 is a block diagram showing an example of like-minded people (“LMP”) data 300. Such an example LMP data may be used in conjunction with a device, such as a mobile device, for federated LMP proximity and interest matching purposes. For example, a person carrying a PDA including LMP capability may be interested in meeting other Yankees fans. This person, Bob, may indicate this interest via LMP data and functionality included with his PDA. The next time Bob is near another Yankees fan who has a similarly configured LMP-enabled device, Bob may be made aware via his PDA of the other fan's presence.

A user of an LMP system, such as Bob in the Yankees fan example, may define or create an LMP board 311. Such an LMP board is typically used to make a user's interests know and/or to detect other's interests. In the Yankees fan example, Bob created an LMP board including his interest in meeting other Yankees fans. An LMB board, such as board 311, typically includes several data elements, such as example elements 320-385, that at least partially define LMP data 300. LMP board 311 typically provides for defining interest sets and related data, transmitting and/or receiving of such interest sets, and detecting common interests. For example, Bob may define his interest in meeting other Yankees fans and have this interest posted on LMP board 311 of a mobile device such as his PDA such that any other similar Yankees fans may be detected. Alternatively or additionally, LMP board 311 and/or the data associated with LMP board 311 may be stored somewhere on a network other than on the Bob's mobile device.

The data associated with LMP board 311 may alternatively be abstract in nature as opposed to structured as interest sets and the like. For example, Alex may define LMP data that describes the types of people he would like to meet. Cathy may define LMP data that describes the patents she has been granted. David may define LMP data that describes the artwork he has for sale. Such broadly defined LMP data may be matched to interest sets of others or to similarly broadly defined LMP data of others.

The LMP data associated with LMP board 311 is typically made available, at least in part, to other devices, typically via a federation or the like. Such federations may be formed as people carrying LMP-enabled devices come within proximity of one another. Proximity may be determined via geographic locating means such as GPS, triangulation, location beacons, or the like, via connectivity means, such as devices being in sufficient range to couple via wireless means or the like, or via any other suitable means. Other such federations may be created and/or joined as a result of an explicit user command or the like. LMP-enabled devices in such a federation may interact with other LPM-enabled devices in the federation to perform LMP functions such as interest matching and user notification of common interest.

LMP board 311 typically includes a collection 320 of one or more interest types, such as interest type element 320. Interest types may be defined by a user and/or may be defined and/or predefined as part of an LMP standard or convention. In one example, and interest type of “Buy/Sell” indicates an interest in buying or selling something. In another example, an interest type of “Meet” indicates an interest in meeting others based on a specified common interest, such as being Yankee fans, as further defined in LMP data 300. Such interest types or other broadly defined LMP data may be provided as part of an extensible service or as part of a plug-in model. For example, such interest types could be provided by a reputable brokerage service or employment service or the like, and then customized by a user to reflect user-specific interests.

Each interest type, such as example interest type 321, typically includes a set ACL 370 and a set of one or more interests 380. Set access control list (“ACL”) 370 typically controls access to a particular interest set of a particular interest type, such as interest set 380 of interest type 321. Such an ACL may be used to identify users who may or may not be made aware of a particular set of interests. For example, in the Yankees fan example, Bob may set the “Meet” set ACL 370 such that only those that are among his friends and family are considered in Bob's interest in meeting other Yankees fans. In another example, Bob may exclude anyone in a group of fellow employees from being considered. Thus, set ACL 370 may be used to define both allow and block lists for various forms of access to a set of interests.

The format and/or structure of set ACL 370 may be any suitable for identifying entities with or without access rights to interests of a particular type, such as interest set 380 of type 321. Such entities may be users, groups, members of federations, or any other entity type or collection of entities. Each such entity is typically identified by a unique identifier. Set ACL 370 typically supports multiple identifiers. For example, set ACL 370 may support a number of identifiers (“IDs”) for individual users as well as IDs for federations and/or groups or the like, typically indicating that such an individual user and/or any member or user of such a federation or group is or is not authorized to access the associated interest set. Set ACL 370 may also control access to a set of interests for actions other than matching, such as the ability to create, modify and/or delete a set of interests. Further, set ACL 370 may also be used to control access to information about a set of interest and/or any of its associated data, thus providing some degree of security and/or privacy via sufficient security and privacy means.

Each interest in a set, such as example interest 381 in set 380, typically includes several data elements, such as properties 382, Interest ACL 383, contact types 384, notification types 385, and conditions 386. In other examples, different or other data elements may be included. For example, in the Yankees fan example, Bob defined example interest 380 as “Yankees Fans” which is of example interest type 321 “Meet”, thus indicating an interest to meet other Yankees fans. The format and/or structure of interest 381 may be any suitable for identifying an interest among a set of interests, such as interest 381 in set 380.

Properties 382 typically include matching criteria for an interest. For example, properties may include various expressions of a particular interest such that regardless of how the interest is expressed by another, a match may be determined. For example, in the Yankees fans example, properties 382 may include the strings “Yankees fans”, “New York Yankees fans”, and/or any other string, expression, description, or the like sufficient to identify the interest for matching purposes or the like. Properties 382 may include other data defining, describing, identifying, or the like the interest. The format and/or structure of properties 382 may be any suitable for defining, including for matching purposes, an interest among a set of interests, such as interest 381 in set 380.

Interest ACL 383 typically controls access to a particular interest in an interest set, such as interest set 380. Such an ACL may be used to identify users who may or may not be made aware of a particular interest. For example, in the Yankees fan example, Bob may set the “Yankees Fans” interest ACL 383 such that his wife is excluded from seeing this interest. The format and/or structure of interest ACL 383 may be any suitable for identifying entities with or without various access rights to a particular interest, such as interest 381 of set 380. Such entities may include users, groups, members of federations, or any other entity type or collection of entities. Each such entity is typically identified by a unique identifier. Interest ACL 383 typically supports multiple identifiers. For example, interest ACL 383 may support a number of identifiers (“IDs”) for individual users as well as IDs for federations and/or groups or the like, typically indicating that such individual users and/or any member or user of such a federation or group is or is not authorized to access the associated interest. Interest ACL 383 may also control access to an interest for actions other than matching, such as the ability to create, modify and/or delete the interest. Further, interest ACL 383 may also be used to control access to information about an interest and/or any of its associated data, thus providing some degree of security and/or privacy via sufficient security and privacy means.

Contact types 384 typically identify the various types of contact information the user is willing to provide to a matching user. Such contact information is typically defined by contact data element 340. Examples of contact types that a user may be willing to provide include name, address, phone number, email address, alias, and/or any other suitable contact or identifying information. For example, in the Yankees fan example, when another fan is detected in proximity, Bob may have specified that his name and text messaging number be provided to the matching user. In another example, Bob may wish to remain anonymous and not provide any contact information to a matching user. The format and/or structure of contact types 384 may be any suitable for identifying the authorized contact information to be provided to another user for a particular matching interest, such as interest 381 of set 380.

Contact types 384 may alternatively or additionally identify various types of validation and/or authentication services or the like. For example, in the Yankees fan example, Bob may be unwilling to provide any personal or contact information to a matching user until a reputable service vouches for the matching user. Such vouching may include validating that the matching person is who they claim to be, that the person is in good standing with the service, or any other type of vouching or the like.

Notification types 385 typically identify the various types of notification information and/or styles the user desires to receive upon a matching user. Such notification information may be defined or entered via any suitable means. Examples of notification types that a user may desire to receive may include instant messages, email messages, beeps, ring tones, voice alerts, vibrations, dialog boxes, and/or any other suitable notification type. For example, in the Yankees fan example, when another fan is detected in proximity, Bob may have specified that he be notified via his cell phone by a vibration and a dialog box indicating whatever contact information is available for the other fan. The format and/or structure of notification types 385 may be any suitable for identifying the notification types and information to be provided upon discovery of a matching interest, such as interest 381 of set 380.

Contact data 340 typically includes contact information of the user of an LMP-enabled device. Contact data 340 may include information provided, at least in part, to other LMP users discovered to have matching interests. Such contact data typically includes name, address, phone number, email address, alias, ring tone, digital photo or image, and/or any other suitable contact or identifying information. Such notification information may be defined or entered via any suitable means. The format and/or structure of contact data 340 may be any suitable for storing and accessing the contact data.

LMP board ACL 350 typically controls access to LMP board 311. In the Yankees fan, Bob may sets LMP board ACL 350 such that only those that are part of his friends and family are considered in Bob's interest in meeting other Yankees fans or any other interests Bob may have defined and exposed via LMP board 311. The format and/or structure of LMP board ACL 350 may be any suitable for identifying entities with or without various access rights to LMP board 311 Such entities may include users, groups, members of federations, or any other entity type or collection of entities. Each such entity is typically identified by a unique identifier. LMP board ACL 350 typically supports multiple identifiers. For example, LMP board ACL 350 may support a number of identifiers (“IDs”) for individual users as well as IDs for federations and/or groups or the like, typically indicating that such individual users and/or any member or user of such a federation or group is or is not authorized to access the associated LMP board. LMP board ACL 350 may also control access to an LMP board for actions other than matching, such as the ability to create, modify and/or delete the interest types and other related information. Further, LMP board ACL 350 may also be used to control access to information about LMP board 311 and/or any of its associated data, thus providing some degree of security and/or privacy via sufficient security and privacy means.

Source ID 360 typically identifies the creator or owner of LMP board 311. In the Yankees fan example, source ID 360 may include an ID for Bob, indicating that Bob is the creator and owner of LMP board 311. The format and/or structure of source ID 350 may be any suitable for identifying the creator or owner of an LMP board, such as LMP board 311.

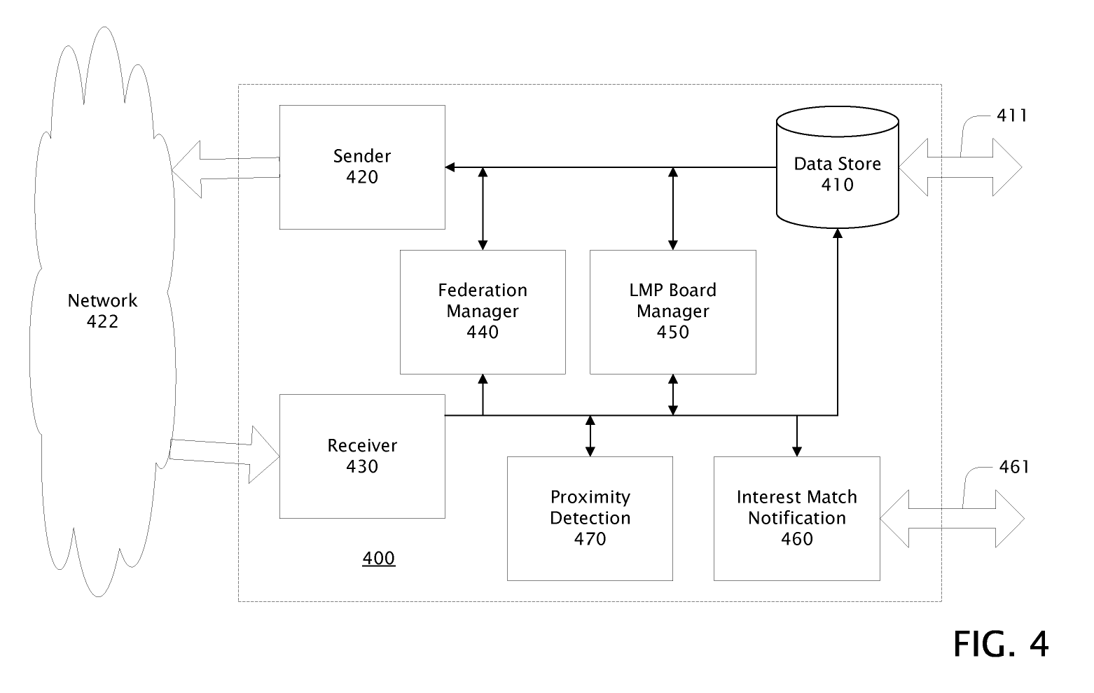

FIG. 4 is a block diagram showing an example like-minded people (“LMP”) device or system 400. System 400 may be implemented in software, hardware, firmware, or the like, or any combination of the foregoing. System 400 typically operates on or as part of a device such as a mobile device. Alternatively, system 400 may be a distributed system with various elements operating on various devices, systems or the like. System 400 is comprised of elements including data store 410, interfaces 411 and 461, sender 420, receiver 430, LMP board manager 440, federation manager 450, and interest match notification process 460. System 400 also utilizes data structures such as LMP data structure 300 described in connection with FIG. 3. Arrows shown in FIG. 4 represent example interactions and communications between elements of system 400. Other interactions and communications may also exist between elements not represented in FIG. 4.

Example data store 410 is a mechanism sufficient to store LMP data and data structures, such as data structure 300 described in connection with FIG. 3, as well as other LMP data. Data store 410 may be volatile or non-volatile and may include system memory and/or mass storage such as described in connection with FIG. 6. Data store 410 may be local to a source system or device, or remotely located.

Example interface 411 is a means for creating, updating, managing and the like LMP information and related data. Example interface 461 is a means of communicating LMP notifications and associated or related information to users of system 400. Such an interface may include appropriate user interface mechanisms and/or application and/or systems interface mechanisms.

Example sender 420 is a means for sending, transmitting, broadcasting, or the like, LMP information, such as LMP data structures, and/or other information or data to other devices and/or systems. In one example, such information is sent via network 422. Such sending may be to specific other devices and/or systems, to all devices/systems in a federation of devices or the like, to some subset of devices/systems, or to any device/system without limitation. In one example, sender 420 is a network interface that may be coupled to one or more networks. System 400 may send data structures, such as LMP data structures, and/or other information via sender 420 to other devices/systems.

Example receiver 430 is a means for receiving, accepting, obtaining, or the like LMP information and/or other information or data from other devices or systems. In one example, such information is received via network 422. Such receiving may be from specific other devices and/or system, from all devices/systems in a federation of devices or the like, from some subset of devices/systems, or from any device/system without limitation. In one example, receiver 430 is a network interface that may be coupled to one or more networks. LMP data and/or other information received by receiver 430 may be utilized to update LMP information stored in data store 410, for interest matching and notification, and/or for other purposes.

Example federation manager (“FM”) 440 is a means for forming, detecting, joining, and otherwise interacting with LMP-enabled federations or the like. In one example, FM 440 sends sufficient information via sender 420 to other devices to form a federation for LMP purposes that can be joined by the other devices. In another example, FM 440 receives sufficient information via receiver 430 such that device 400 can detect and join federations or the like. Further, FM 440 typically detects the presence of LMP-enabled devices and sends/receives LMP data structures or portions thereof, such as those stored in data store 410 or the like, to/from other LMP-enabled devices.

Example LMP board manager 450 is a means of comparing LMP data from other devices and systems with LMP data stored in data store 410 defining the interests of the device's user. Further, LMP board manager is also a means of managing the sending of LMP data stored in data store 410 defining the interests of the device's user to other devices and systems. In one example, LMP board manager 450 sends interest types, such as interest types 320 defined in connection with FIG. 3, to other devices. Such other devices may subsequently request a set of interests, such as interest set 380 defined in connection with FIG. 3, for one or more of the interest types, and so on until a match is either discovered or ruled out. Additionally or alternatively, LMP board manager 450 managing the comparison of LMP data received and request further data until a match is either discovered or ruled out. In the event of an interest match, LMP board manager 450 may send contact information to the matching device as specified by contact types data, as defined by contact types 384 in connection with FIG. 3, for the matched interest.

Interest match notification (“IMN”) process 460 is a means for providing interest match notifications to the user of system 400. LMP board manager 450 may initiate a notification via interest match notification (“IMN”) process 460 upon detection of an interest match. Such notifications typically conform to those defined by notification types data, as defined by notification types 385 in connection with FIG. 3, for the matched interest. Such notification may include instant messages, email messages, beeps, ring tones, voice alerts, vibrations, dialog boxes, any other suitable notification type, and/or combination of the foregoing.

Proximity detection (“PXD”) process 470 is a means for detecting the geographic or physical proximity between system 400 and another LMP-enabled device. Such proximity detection may make used of sending and/or receiving signal strength, GPS information, triangulation, location beacon information, and/or any other suitable proximity information and/or mechanisms, or any combination of the foregoing. One condition of an interest match as defined by example conditions 386 described in connection with FIG. 3 may be the physical proximity between devices with and otherwise verified interest match. For example, if two devices are separated by a distance greater than that specified, a common interest that would otherwise be considered a match will not be matched.

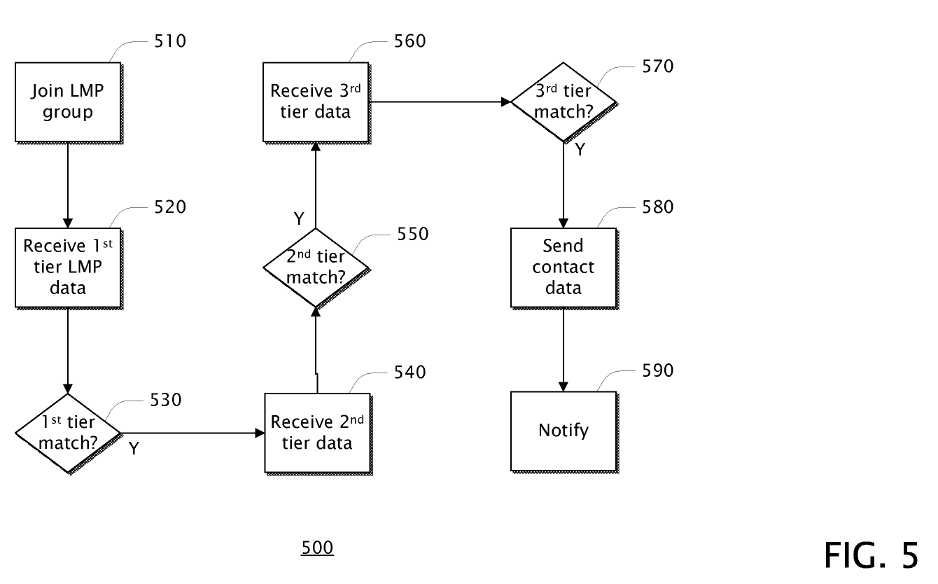

FIG. 5 is a block diagram showing an example process 500 for detecting common interests among persons represented by devices in a federation of devices. Other processes or methods may similarly be used, and persons or any other entities may be represented by devices organized in a structure other than a federation of devices. Any structure of devices able to provide sufficient communication between devices may be used. Example method 500 makes use of an LMP data structure, such as LMP data structure 300 shown in connection with FIG. 3. Other LMP data structures or organizations of LMP data may similarly be used. Process 500 typically begins at block 510.

Block 510 indicates a device joining an LMP group. In one example, an LMP group may be a federation of devices. In another example, an LMP group may be any organization of devices suitable for LMP purposes. An LMP group may be formed as part of joining the group, if not already formed. Typically two or more devices form a group, at least in the case where each device represents a single person or entity. Where a single device represents more than one person, such a group may be considered to form on the device itself. In one example, system 400 as described in connection with FIG. 4 may be the device joining the LMP group. Other such devices may already be joined to the LMP group. Process 500 typically continues at block 520.

Block 520 indicates receiving first tier LMP data provided by one or more other devices in the LMP group, or provided by the device itself if the device represents more then one person or entity. Such first tier data may be a set of interest types, such as interest types 320 as described in connection with FIG. 3. Other data associated with the interest types may also be received sufficient to associate the interest type data with the persons represented and their associated devices. Process 500 typically continues at block 530.

Block 530 indicates a comparison to determine if any of the received first tier LMP data matches any first tier LMP data of the person represented by the device. For example, if Bob's device joins a federation of devices and one of his interest types is “Meet”, if a matching interest type is received from any other device in the federation, then an interest type match or first tier LMP data match is detected. If a first tier LMP data match is detected, then process 500 typically continues at block 540.

Block 540 indicates receiving second tier LMP data provided by the device that sent matching first tier LMP data. Such receiving typically occurs in response to a request sent for such data upon detection of a first tier LMP data match. Such second tier LMP data may be a set of interests of the matched interest type, such as interest set 380 of interest type 321 as described in connection with FIG. 3. Other data associated with the interest set may also be received sufficient to associate the interest set with the person represented and their associated device. Process 500 typically continues at block 550.

Block 550 indicates a comparison to determine if any of the received second tier LMP data matches any second tier LMP data of the person represented by the device. For example, given that Bob has defined an interest set including a “Yankees Fans” interest which is of interest type “Meet”, thus indicating an interest to meet other Yankees fans, if at least one matching interest in the interest set of the matching interest type is received from a device in the federation, then an interest set match or second tier LMP data match is detected. If a second tier LMP data match is detected, then process 500 typically continues at block 560.

Block 560 indicates receiving third tier LMP data provided by the device that sent matching first and second tier LMP data. Such receiving typically occurs in response to a request sent for such data upon detection of a second tier LMP data match. Such third tier LMP data may be data associated with a specific matched interest of the matched interest type, such as interest 381 of interest set 380 of interest type 321 as described in connection with FIG. 3. Other data associated with the interest may also be received sufficient to define the interest and associate the interest with the person represented and their associated device. Process 500 typically continues at block 570.

Block 570 indicates a test to determine if any of the received third tier LMP data and/or any of the third tier LMP data on the device verifies an interest match. For example, given that Bob has defined an interest set including a “Yankees Fans” interest which is of interest type “Meet”, thus indicating an interest to meet other Yankees fans, but has also added a condition to exclude his wife, if the otherwise matching interest is not associated with Bob's wife, then the interest match or third tier LMP data match is verified. Interest conditions may include conditions 386 described in connection with FIG. 3. Other data that may be used in verifying an interest match in properties and ACLs such as properties 382 and interest ACL 384 described in connection with FIG. 3. Interest match verifications may make use of received data and/or data stored on the local device. If a third tier LMP data match is detected, then process 500 continues at block 580.

Block 580 indicates sending contact data to the device providing the matching interest. Such contact data may be specified by contact types data such as contact types 384 as described in connection with FIG. 3. For example, if Sue turns out to be a Yankees fan and a matching interest is detected between Sue's device and Bob's device, then Bob's device may send Bob's text messaging information to Sue based on how Bob previously configured his device to respond in the event of such a match. In another example, Bob may wish to remain anonymous to Sue and not send any contact information to Sue's device. Process 500 typically continues at block 590.

Block 590 indicates notifying the user of the device of a matching interest. The types and/or formats of such notifications may be specified by notification types data such as notification types 385 as described in connection with FIG. 3. For example, if Sue turns out to be a Yankees fan and a matching interest is detected between Sue's device and Bob's device, then Bob's device may notify him via a vibration as well as a dialog box indicating the interest match and providing contact information for Sue.

FIG. 6 is a block diagram showing an example computing environment 600 in which the technologies described above may be implemented. A suitable computing environment may be implemented with numerous general purpose or special purpose systems. Examples of well known systems may include, but are not limited to, cell phones, personal digital assistants (“PDA”), personal computers (“PC”), hand-held or laptop devices, microprocessor-based systems, multiprocessor systems, servers, workstations, consumer electronic devices, set-top boxes, and the like.

Computing environment 600 typically includes a general-purpose computing system in the form of a computing device 601 coupled to various components, such as peripheral devices 602, 603, 604 and the like. System 600 may couple to various other components, such as input devices 603, including voice recognition, touch pads, buttons, keyboards and/or pointing devices, such as a mouse or trackball, via one or more input/output (“I/O”) interfaces 612. The components of computing device 601 may include one or more processors (including central processing units (“CPU”), graphics processing units (“GPU”), microprocessors (“μP”), and the like) 607, system memory 609, and a system bus 608 that typically couples the various components. Processor 607 typically processes or executes various computer-executable instructions to control the operation of computing device 601 and to communicate with other electronic and/or computing devices, systems or environment (not shown) via various communications connections such as a network connection 614 or the like. System bus 608 represents any number of several types of bus structures, including a memory bus or memory controller, a peripheral bus, a serial bus, an accelerated graphics port, a processor or local bus using any of a variety of bus architectures, and the like.

System memory 609 may include computer readable media in the form of volatile memory, such as random access memory (“RAM”), and/or non-volatile memory, such as read only memory (“ROM”) or flash memory (“FLASH”). A basic input/output system (“BIOS”) may be stored in non-volatile or the like. System memory 609 typically stores data, computer-executable instructions and/or program modules comprising computer-executable instructions that are immediately accessible to and/or presently operated on by one or more of the processors 607.

Mass storage devices 604 and 610 may be coupled to computing device 601 or incorporated into computing device 601 via coupling to the system bus. Such mass storage devices 604 and 610 may include non-volatile RAM, a magnetic disk drive which reads from and/or writes to a removable, non-volatile magnetic disk (e.g., a “floppy disk”) 605, and/or an optical disk drive that reads from and/or writes to a non-volatile optical disk such as a CD ROM, DVD ROM 606. Alternatively, a mass storage device, such as hard disk 610, may include non-removable storage medium. Other mass storage devices may include memory cards, memory sticks, tape storage devices, and the like.

Any number of computer programs, files, data structures, and the like may be stored in mass storage 610, other storage devices 604, 605, 606 and system memory 609 (typically limited by available space) including, by way of example and not limitation, operating systems, application programs, data files, directory structures, computer-executable instructions, and the like.

Output components or devices, such as display device 602, may be coupled to computing device 601, typically via an interface such as a display adapter 611. Output device 602 may be a liquid crystal display (“LCD”). Other example output devices may include printers, audio outputs, voice outputs, cathode ray tube (“CRT”) displays, tactile devices or other sensory output mechanisms, or the like. Output devices may enable computing device 601 to interact with human operators or other machines, systems, computing environments, or the like. A user may interface with computing environment 600 via any number of different I/O devices 603 such as a touch pad, buttons, keyboard, mouse, joystick, game pad, data port, and the like. These and other I/O devices may be coupled to processor 607 via I/O interfaces 612 which may be coupled to system bus 608, and/or may be coupled by other interfaces and bus structures, such as a parallel port, game port, universal serial bus (“USB”), fire wire, infrared (“IR”) port, and the like.

Computing device 601 may operate in a networked environment via communications connections to one or more remote computing devices through one or more cellular networks, wireless networks, local area networks (“LAN”), wide area networks (“WAN”), storage area networks (“SAN”), the Internet, radio links, optical links and the like. Computing device 601 may be coupled to a network via network adapter 613 or the like, or, alternatively, via a modem, digital subscriber line (“DSL”) link, integrated services digital network (“ISDN”) link, Internet link, wireless link, or the like.

Communications connection 614, such as a network connection, typically provides a coupling to communications media, such as a network. Communications media typically provide computer-readable and computer-executable instructions, data structures, files, program modules and other data using a modulated data signal, such as a carrier wave or other transport mechanism. The term “modulated data signal” typically means a signal that has one or more of its characteristics set or changed in such a manner as to encode information in the signal. By way of example, and not limitation, communications media may include wired media, such as a wired network or direct-wired connection or the like, and wireless media, such as acoustic, radio frequency, infrared, or other wireless communications mechanisms.

Power source 690, such as a battery or a power supply, typically provides power for portions or all of computing environment 600. In the case of the computing environment 600 being a mobile device or portable device or the like, power source 690 may be a battery. Alternatively, in the case computing environment 600 is a desktop computer or server or the like, power source 690 may be a power supply designed to connect to an alternating current (“AC”) source, such as via a wall outlet.

Some mobile devices may not include many of the components described in connection with FIG. 6. For example, an electronic badge may be comprised of a coil of wire along with a simple processing unit 607 or the like, the coil configured to act as power source 690 when in proximity to a card reader device or the like. Such a coil may also be configure to act as an antenna coupled to the processing unit 607 or the like, the coil antenna capable of providing a form of communication between the electronic badge and the card reader device. Such communication may not involve networking, but may alternatively be general or special purpose communications via telemetry, point-to-point, RF, IR, audio, or other means. An electronic card may not include display 602, I/O device 603, or many of the other components described in connection with FIG. 6. Other mobile devices that may not include many of the components described in connection with FIG. 6, by way of example and not limitation, include electronic bracelets, electronic tags, implantable devices, and the like.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data and may execute any computer-executable instructions. Alternatively, the local computer may download pieces of the software or data as needed, or distributively process the software by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” typically refers to executable instructions, code, data, applications, programs, or the like maintained in an electronic device such as a ROM. The term “software” generally refers to executable instructions, code, data, applications, programs, or the like maintained in or on any form of computer-readable media. The term “computer-readable media” typically refers to system memory, storage devices and their associated media, and the like.

In view of the many possible embodiments to which the principles of the present invention and the forgoing examples may be applied, it should be recognized that the examples described herein are meant to be illustrative only and should not be taken as limiting the scope of the present invention. Therefore, the invention as described herein contemplates all such embodiments as may come within the scope of the following claims and any equivalents thereto.

1. A system for associating people via devices based on a common interest, the system comprising:
an association between a first person and the system;
first interest data of the first person stored on the system;
a receiving means;
a sending means;
a federation manager coupled to the receiving means and to the sending means and operable to form a federation of devices including the system; and
a like-minded people (“LMP”) board manager coupled to the receiving means and to the sending means and operable to compare second interest data from a device of the federation of devices, the device being associated with a second person, to the first interest data of the first person so as to detect the common interest between the first person and the second person.

2. The system of claim 1 wherein the federation of devices is formed in an ad-hoc manner.

3. The system of claim 1 further comprising a data store operable to store the first interest data of the first person.

4. The system of claim 1 further comprising a notification means coupled to the LMP board manager.

5. The system of claim 4 wherein the LMP board manager provides an interest match notification to the first person via the notification means upon detection of the common interest between the first person and the second person.

6. The system of claim 1 further comprising contact data of the first person.

7. The system of claim 6 wherein the LMP board manager sends, upon detection of the common interest between the first person and the second person, at least a portion of the contact data of the first person via the sending means to the device of the federation of devices.

8. The system of claim 1 further comprising a proximity means operable to determine an estimated geographical distance between the system and the device of the federation of devices.

9. The system of claim 8 wherein the detection of the common interest between the first person and the second person is based, at least in part, on the estimated geographical distance between the system and the device of the federation of devices.

10. A method for associating entities via devices based on a common interest, the method comprising:
a first device associated with a first entity joining a like-minded people group, the first device including first common interest data;
receiving second common interest data from a second device associated with a second entity wherein the second device is a member of the like-mind people group;
comparing the first common interest data with the second common interest data; and
determining a common interest match, based at least in part on the comparing, between the first entity and the second entity.

11. The method of claim 10 wherein the like-minded people group is an ad-hoc federation.

12. The method of claim 10 further comprising estimating an estimated physical proximity of the first device and the second device.

13. The method of claim 12 wherein the determining a common interest match is based, at least in part, on the estimated physical proximity of the first device and the second device.

14. The method of claim 10 further comprising, upon the determining a common interest match, sending contact data from the first device to the second device.

15. The method of claim 10 further comprising, upon the determining the common interest match, notifying the first entity of the common interest match.

16. The method of claim 10 wherein the first common interest data is partitioned into tiers.

17. The method of claim 10 wherein the common interest match represents a buy/sell interest.

18. The method of claim 10 embodied as computer-executable instruction on computer-readable media.

19. A method for associating entities via devices based on a common interest, the method comprising:
a first device associated with a first entity joining an ad-hoc federation of devices, the first device including first common interest data;
receiving interest types data from a second device associated with a second entity wherein the second device is of the ad-hoc federation of devices;
detecting a common interest type in the first common interest data with the interest types data from the second device;
receiving interest set data from the second device;
detecting a common interest in the first common interest data with the interest set from the second device;
determining a common interest match, based at least in part on the detecting a common interest type and the detecting a common interest, between the first entity and the second entity;
sending contact information associated with the first entity to the second device; and
notifying the first entity via the first device of the common interest match.

20. The method of claim 19 embodied as computer-executable instructions stored on at least one computer-readable medium.
